(19) United States
(12) Patent Application Publication
(10) Pub. No.: US 2017/0185945 A1
(43) Pub. Date: Jun. 29, 2017

(54) DYNAMIC INTERACTION PACING

(71) Applicant: Avaya Inc., Santa Clara, CA (US)

(72) Inventors: Valentine C. Matula, Granville, OH (US); David Skiba, Golden, CO (US); George Erhart, Loveland, CO (US)

(21) Appl. No.: 14/982,364

(22) Filed: Dec. 29, 2015

(51) Int. Cl. G06Q 10/06; H04M 3/523; G06Q 30/00

(52) U.S. Cl. CPC G06Q 10/063114; G06Q 30/016; H04M 3/5238

(57) ABSTRACT

Contact centers often balance the business needs to efficiently operate with the objective of providing timely service to customers interacting with the contact center. Often contact centers are unable to connect customers to live agents without a period of hold time, usually to wait for an agent to become available. Automated resources, such as interactive voice response or automated text-based response components, may gather information from the customer. When an estimated wait time for a live agent is longer than the estimated time required to perform that automated interaction, artificial delays (e.g., slow-downs, pauses, echoes, etc.) may be inserted to keep the customer engaged in an effort to retain the customer beyond an estimated abandonment time.

### FIELD OF THE DISCLOSURE

The present disclosure is generally directed towards temporal management of enqueued transactions on a communications system.

### BACKGROUND

Contact centers often determine an Estimated Wait Time (EWT) and provide the EWT to customers as an estimation of how long they might have to wait in queue. EWT factors in how many agents are on shift, how many calls are in queue, and how long each call takes on average.

EWT has limitations, including, but not limited to, variability around shift change, agent skill sets, the number of dedicated agents, and whether calls have similar durations or vary widely.

Contact centers must determine whether or not EWT is beneficial or becomes a disincentive for customers to wait in queue. The customer's perception is important to consider.

### SUMMARY

While improving EWT accuracy may improve customer experience, there may be other means to improve customer perception of a queue experience.

By way of general introduction, and in one embodiment, systems and methods are provided that pace a customer's traversal through an Interactive Voice Response (IVR) or other prompt system so that the customer's perception of their actual wait time is diminished. In another embodiment, systems and methods are provided to provide dynamic interaction pacing to reduce the customer's perception of their wait time in queue.

In one embodiment, distraction injection is provided during transfer, connection, routing determination, IVR interaction, and/or other portion of a call or other communication other than an interaction to address a purpose for the call or communication. The distraction injection is provided to reduce a customer's perception of the actual hold time length. The EWT is accessed and a determination is made on how much time should be added to a customer interaction prior to queue entry. The system approximates the total time until an agent will be available. Based on pre-set/predefined thresholds, one or more slow-downs/delay insertions can be implemented.

In general, customers will not accept a wait time past a certain point. Most companies have a history of call, or other communication, abandonments that indicate a threshold of unacceptable delay for their customers. For example, a significant number of customers will not accept “X” amount of delay, therefore, the system may use X/A, wherein “A” is an anticipated number of interactions to determine one metric for delay insertion. For example, if X equals three minutes and A equals six interactions, then thirty seconds of delay should be applied to each interaction. In other embodiments, the delay applied to each interaction may vary to achieve a target average delay of thirty seconds for all six interactions.

Delay insertion is variously embodied and comprises automated interactions that would occur at a first pace, but with the delay insertion, occur at a second, slower pace. Delay insertion embodiments include, but are not limited to, one or more of the following:

a. Slow down IVR prompt playback speed by (e.g., 10%) and apply pitch scaling/shifting to slow down an IVR interaction;

b. Insert delays in character echo in automated text chats to increase the time to display a message on a customer's communication device;

c. Switch to a more verbose prompt set in an IVR interaction;

d. Add pauses between dialog turns to extend the response time to an amount not exceeding the maximum pause delay a user will tolerate when sending responses in an automated chat; and

e. Use longer, more verbose responses during an automated text chat.

In one embodiment, a server is disclosed, comprising: a network interface to a communications network; a processor: accessing a communication with a customer; initiating an automated interaction portion of an interaction with the customer and an automated resource; determine an estimated wait time (EWT) for the customer to interact with an agent; accessing a likely abandonment time; and upon determining the EWT is greater than the likely abandonment time, inserting a delay into the automated interaction portion of the communication.

In another embodiment, a means for inserting a delay in an interaction is disclosed, comprising: means to access a communication with a customer; means to initiate an automated interaction portion of an interaction with the customer and an automated resource; means to determine an estimated wait time (EWT) for the customer to interact with an agent; means to access a likely abandonment time; and means to, upon determining the EWT is greater than the likely abandonment time, insert a delay into the automated interaction portion of the communication. In a further embodiment, the means provided comprise at least one processor, such as a microprocessor, server, server array, distributed processor (e.g., “cloud”), etc.

In another embodiment, a method is disclosed, comprising accessing a communication with a customer; initiating an automated interaction portion of an interaction with the customer and an automated resource; determining an estimated wait time (EWT) for the customer to interact with an agent; accessing a likely abandonment time; and, upon determining the EWT is greater than the likely abandonment time, inserting a delay into the automated interaction portion of the communication.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a first process flow in accordance with embodiments of the present disclosure;

FIG. 3 depicts a second process flow in accordance with embodiments of the present disclosure;

FIG. 4 depicts a delay strategy compatibility table in accordance with embodiments of the present disclosure; and

FIG. 5 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

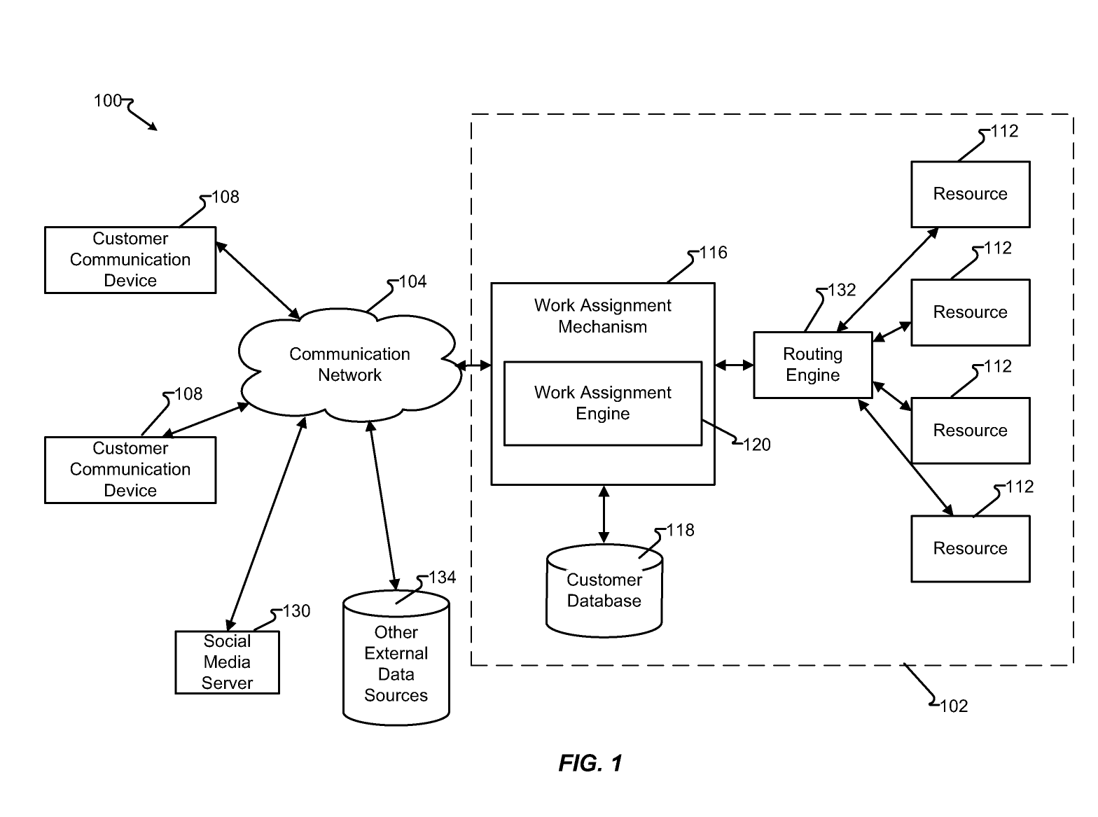

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 112, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 104.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication at which point the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

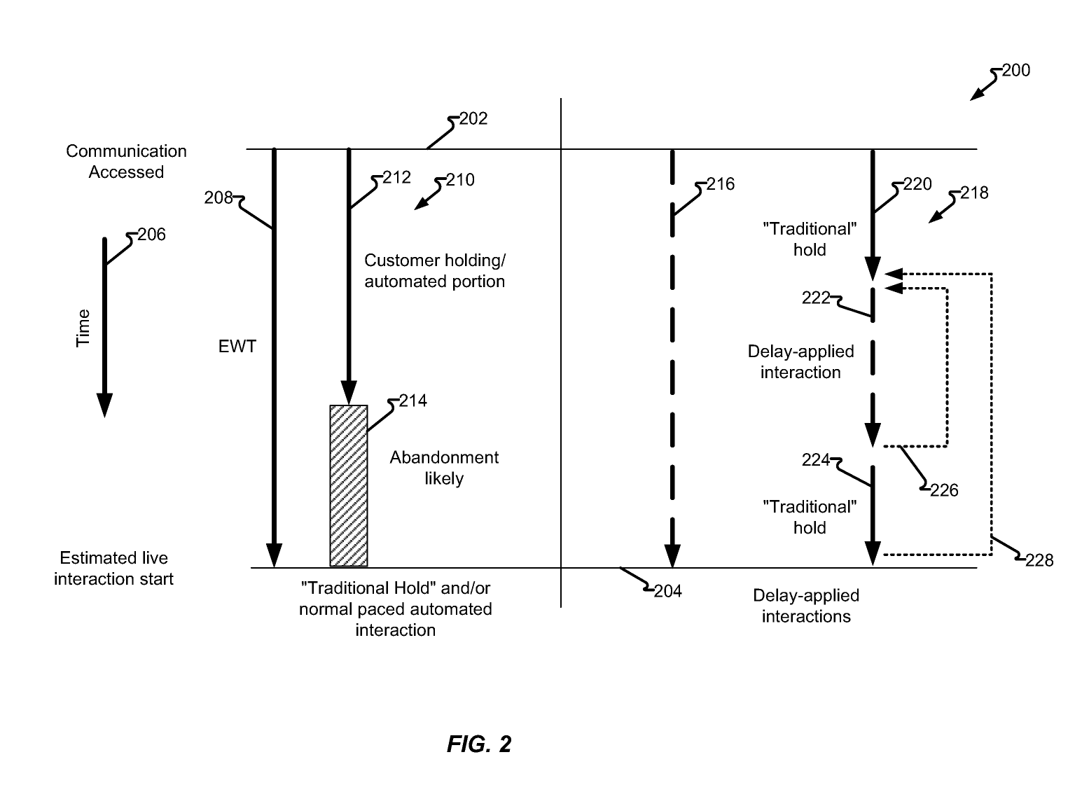

FIG. 2 depicts process flow 200 in accordance with embodiments of the present disclosure. Process flow 200 begins at a first time with communication accessed 202. In one embodiment, communication access 202 occurs when a customer contacts a contact center, such as by voice/video interaction, text interaction, or other real-time or near real-time communication. In another embodiment, contact center 102 may initiate the contact, such as via a callback mechanism, outbound call, etc. Time 206 progresses from communication access 202 to estimated live interaction start 204.

An estimated wait time (EWT) 208 is accessed and indicates the amount of time 206 from communication access 202 to estimated live interaction start 204. EWT 208 may be calculated after communication access 202 occurs, before communication access 202 occurs, or retrieved from a previously determined value for EWT 208. Call flow 210 comprises portions designated as holding/automated interaction 212 and abandonment likely 214. Abandonment likely 214 may incorporate holding/automated interactions similar to those provided in holding/automated interactions 212; however, abandonment likely 214 occurs after a previously determined threshold wherein abandonment (e.g., call hangup, discontinue text chat, etc.) is likely.

In one embodiment, call flow 216 incorporates at least one delay strategy, such as an interactive voice response (IVR), automated text-chat engine, etc., to lengthen the period of time before an interaction with an automated resource (one of resource 112 when embodied as an automated resource) begins. Call flow 216 may incorporate one or more of extended pauses, more verbose content, echoing customer inputs, slowing the echo-rate of customer inputs, slowing rate of text/speech provided, etc. As a benefit, call flow 216 is extended from communication access 202 to estimated live interaction start 204.

In another embodiment, call flow 218 incorporates one or more delay applied interactions 222. Call flow 218 may begin with traditional hold 220, such as an announcement that the call is being routed to an appropriate party, playing music on hold, or other non-interactive portion of call flow 218. Delay-applied interaction 222 may incorporate one or more activities selected to maintain the customer's attention and retention of call flow 218, such as asking for information not otherwise needed, such as by echoing back customer-provided information and asking the customer to confirm the accuracy of the information.

Call flow 218 may incorporate a second traditional hold 224, such as a preferably short amount of time following an announcement that the call will soon be connected to a live agent, such as one of resource 112 when embodied as a human agent. Call flow 218 may incorporate one or more loop-back steps 226, 228 such as to reinitiate delay-applied interactions 222 a number of additional times. Loopbacks 226, 228 may be incorporated due to discrepancies in EWT 208, wherein an agent has yet to reach the expiration of EWT 208, or may be predetermined to execute delay-applied interaction 222 a number of times as part of call flow 218.

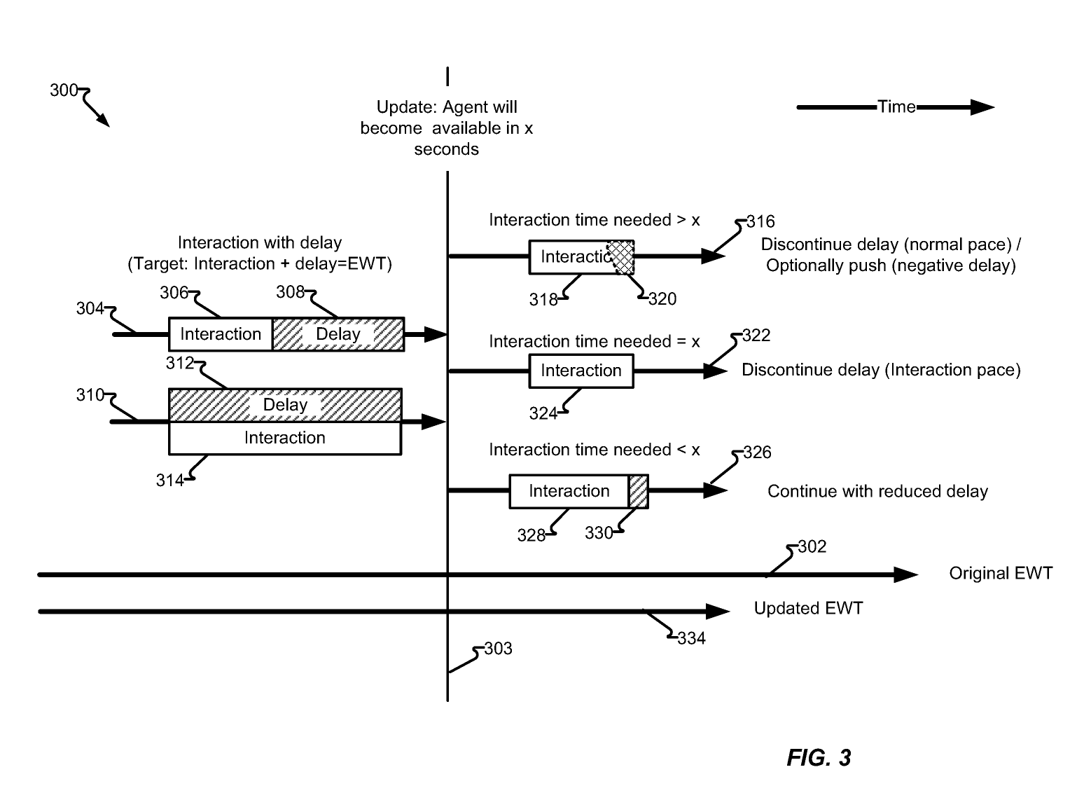

FIG. 3 depicts process flow 300 in accordance with embodiments of the present disclosure. EWT 208 may not accurately indicate when an agent becomes available to accept the communication. Update 303 may occur during the progression of time between the communication being accepted and an original EWT 302, resulting in an updated EWT 334.

In one embodiment, initial call flow 304 comprises an interaction portion 306 and delay portion 308 occurring sequentially. In another embodiment, initial call flow 310 comprises interaction portion 314 and delay portion 312 occurring simultaneously. Delay portion 308 and delay portion 312 are selected based upon extending call flows 304, 310 respectively to substantially coincide with original EWT 302. However, at point 303 an update is received indicating that an agent will soon become available and updated EWT 334 is now determined.

In one embodiment, call flow portion 316 occurs when the interaction time needed is greater than the availability time of the agent. Delay, such as delay portion 308 and delay portion 312, are discontinued. As a further option, a negative delay such as rushing interactive portion 318 may be implemented, such as to gather essential customer information more quickly so that the information gathered during interactive portion 318 is available upon the updated EWT 334. As a further option, interactive portion 318 may defer gathering information and, if needed, prompt the agent to obtain information during a live interaction with the customer.

In another embodiment, call flow portion 322 occurs when the interaction time needed is equal to, or equal to within a predetermined acceptable variance, to coincide with updated EWT 334. Accordingly, interactive portion 324 may continue normally and call flow portion 322 may omit any delay, such as delay portion 308 or delay portion 312.

In another embodiment, call flow portion 326 occurs when the interaction time needed is less than the time required to coincide with updated EWT 334. In which case, interactive portion 328 may continue with an updated delay portion 330 so as to extend interaction portion 328 a different amount to coincide with updated EWT 334.

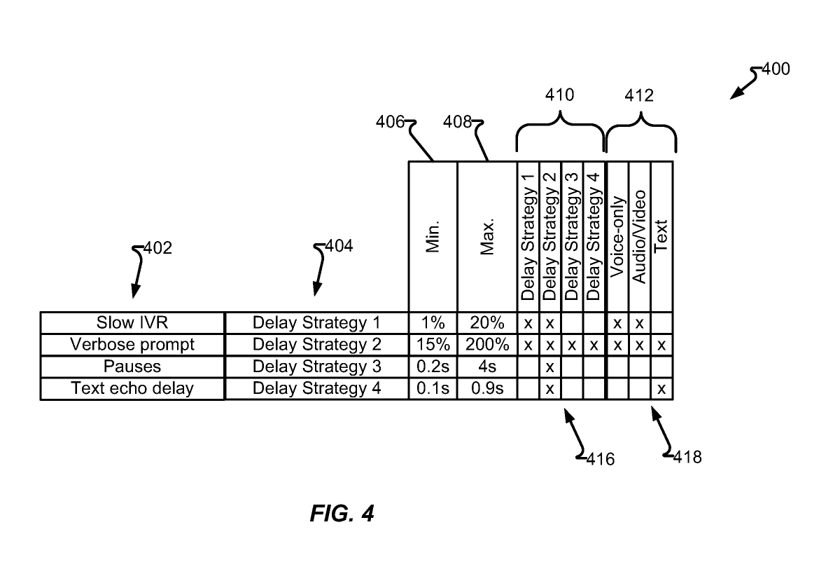

FIG. 4 depicts delay strategy compatibility table 400 in accordance with embodiments of the present disclosure. In one embodiment, strategy compatibility table 400 is provided, such as to a processor or other automated selection means, to indicate available delay strategies 404. Delay strategies 404 may be associated with a human-readable identifier 402, such as to facilitate maintenance or other activities associated with utilization of strategy compatibility table 400.

In another embodiment, ones of delay strategies 404 may be associated with one or more attributes, such as minimum delay amount 406, maximum delay amount 408, compatibility with other strategies 410, and applicability to various communication mediums 412. For example, portion 418 may indicate which of delay strategies 404 are applicable to voice, audio/video, text, or other real-time communication mediums.

Delay minimum 406 and/or delay maximum 408 may be expressed in terms of seconds of delay and/or a percentage of delay, which may be applied to an interactive portion. In another embodiment, compatibility matrix 416 indicates which combination of delay strategies may be implemented together. It should be appreciated, by those of ordinary skill in the art, that although strategy compatibility table 400's portion 410 is provided in a 2×2 matrix, other combinations may be provided indicating which of delay strategies 404, and combinations of three or more, are mutually compatible.

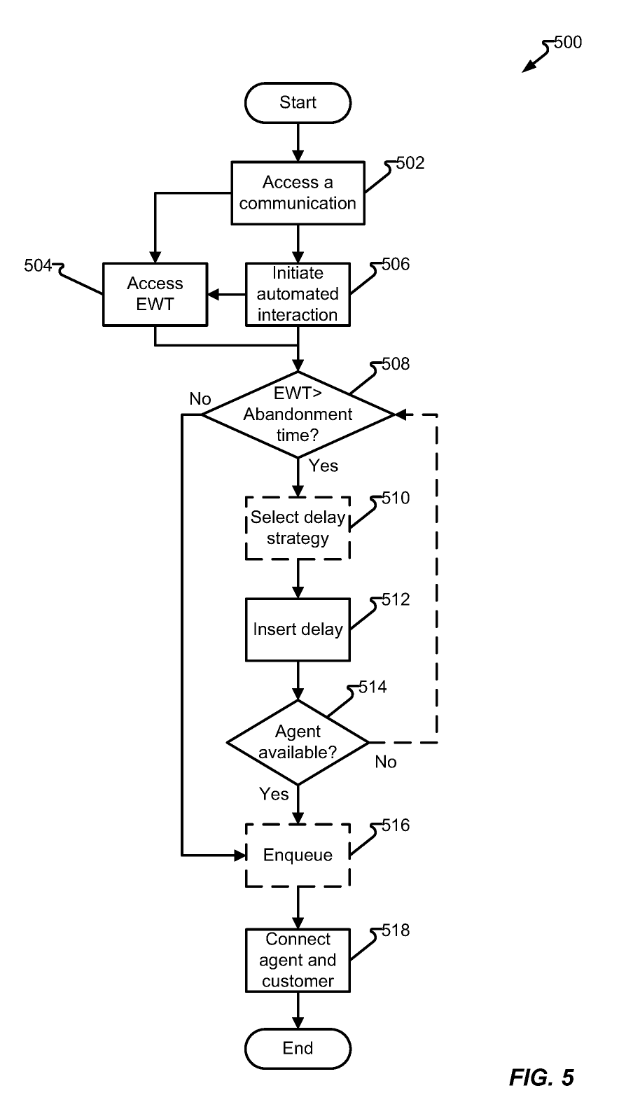

FIG. 5 depicts process 500 in accordance with embodiments of the present disclosure. In one embodiment, process 500 begins with step 502 accessing a communication. Process 500 may be performed by a dedicated processor, plurality of processors, or as a component of or integrated with a processor performing other tasks, such as one or more of work assignment mechanism 116, work assignment engine 120, routing engine 132, and/or one of resources 112 when embodied as an automated resource.

The communication medium with the customer, such as via a customer communication device 108 over communication network 104, is one of a number of real-time communications that may be initiated by a customer or by the contact center and wherein a live agent associated with the contact center is not able to initially interact with the customer. Step 504 accesses an EWT and optionally calculates or otherwise determines the EWT. Step 504 may be done concurrently with step 506 initiating an automated interaction between an automated resource of the contact center and the customer, or following step 506.

Next, step 508 determines if the EWT is greater than an estimated abandonment time. If no, process 500 may continue to step 516. If not, process 500 may implement step 518. If step 508 is determined in the affirmative, processing may then optionally continue to step 510 whereby a delay strategy is selected, such as to extend an automated portion initiated in step 506 to substantially coincide with the EWT. Step 512 inserts the delay. Then step 514 determines if an agent is available. If step 514 is determined in the negative processing may continue back to step 508 wherein a new EWT may be determined and a new strategy is optionally selected by step 510 and inserted by step 512 until such time as step 514 determines that an agent is available or that an agent will be available within an acceptable period of time, such as within a few seconds. Upon step 514 determining that the agent is available, process 500 may continue to step 516 wherein the agent may optionally be enqueued into an agent's pool of work items. If not, process 500 may implement step 518, which connects the agent and the customer for live interaction, following which step 500 may terminate.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer-readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireless, wireline, optical fiber cable, RF, etc., or any suitable combination of the foregoing.

While illustrative embodiments of the disclosure have been described in detail herein, it is to be understood that the inventive concepts may be otherwise variously embodied and employed and that the appended claims are intended to be construed to include such variations, except as limited by the prior art.

What is claimed is:

1. A server, comprising:
a network interface to a communications network;
a processor:
accessing a communication with a customer;
initiating an automated interaction portion of an interaction with the customer and an automated resource;
determining an estimated wait time (EWT) for the customer to interact with an agent;
accessing a likely abandonment time; and
upon determining the EWT is greater than the likely abandonment time, inserting a delay into the automated interaction portion of the communication.

2. The server of claim 1, wherein determining the EWT is greater than the likely abandonment time, comprises determining the EWT, less the time required for the automated interaction portion, is greater than the likely abandonment time.

3. The server of claim 1, wherein the processor, upon receiving a signal that the agent will become available within a previously determined threshold, discontinues the delay.

4. The server of claim 1, wherein the processor, upon receiving a signal that the agent will become available, re-determines the EWT and updates the delay in accordance with the re-determined EWT.

5. The server of claim 1, wherein the delay comprises an artificial delay in responding to the customer in a portion of an automated exchange during the automated interaction portion.

6. The server of claim 1, wherein the delay comprises an artificial delay in acknowledging an input from the customer in a portion of an automated exchange during the automated interaction portion.

7. The server of claim 6, wherein the delay comprising the artificial delay in acknowledging a text character input from the customer.

8. The server of claim 1, wherein the delay comprises a plurality of delay strategies.

9. The server of claim 8, wherein ones of the delay strategies comprises at least two of slowing the rate of a response from the automated resource, increasing the length of pauses between conversational pauses, increasing the verbosity of a response, confirming additional inputs received by the customer, echoing the inputs received by the customer, or echoing a purpose associated with an input provided by the customer.

10. The server of claim 9, wherein the delay strategies comprise at least two previously identified compatible delay strategies.

11. A means for inserting a delay in an interaction, comprising:
means to access a communication with a customer;
means to initiate an automated interaction portion of an interaction with the customer and an automated resource;
means to determine an estimated wait time (EWT) for the customer to interact with an agent;
means to access a likely abandonment time; and
means to, upon determining the EWT is greater than the likely abandonment time, insert a delay into the automated interaction portion of the communication.

12. The means of claim 11, wherein determining the EWT is greater than the likely abandonment time, comprises determining the EWT, less the time required for the automated interaction portion, is greater than the likely abandonment time.

13. The means of claim 11, upon receiving a signal that the agent will become available within a previously determined threshold, means to discontinue the delay.

14. The means of claim 11, upon receiving a signal that the agent will become available, means to re-determine the EWT and means to update the delay in accordance with the re-determined EWT.

15. The means of claim 11, wherein the delay comprises an artificial delay in responding to the customer in a portion of an automated exchange during the automated interaction portion.

16. A method, comprising:
accessing, by a processor, a communication with a customer;
initiating, by the processor, an automated interaction portion of an interaction with the customer and an automated resource;
determining, by the processor, an estimated wait time (EWT) for the customer to interact with an agent;
accessing, by the processor, a likely abandonment time; and
upon determining the EWT is greater than the likely abandonment time, inserting, by the processor, a delay into the automated interaction portion of the communication.

17. The method of claim 16, wherein the delay comprises an artificial delay in acknowledging an input from the customer in a portion of an automated exchange during the automated interaction portion.

18. The method of claim 17, wherein the delay comprising the artificial delay in acknowledging the input, further comprises an artificial delay in the acknowledgement of a character of a text input from the customer.

19. The method of claim 16, wherein the delay comprises a plurality of delay strategies.

20. The method of claim 19, wherein ones of the delay strategies comprises at least two of slowing the rate of a response from the automated resource, increasing the length of pauses between conversational pauses, increasing the verbosity of a response, confirming additional inputs received by the customer, echoing the inputs received by the customer, or echoing a purpose associated with an input provided by the customer.
